(19) United States
(12) Patent Application Publication
(10) Pub. No.: US 2006/0181395 A1
(43) Pub. Date: Aug. 17, 2006

(54) Techniques to configure radio-frequency identification readers

(75) Inventor: James R. Gruszynski, Margate, FL (US)

Correspondence Address: IP LEGAL DEPARTMENT;TYCO FIRE & SECURITY SERVICES, ONE TOWN CENTER ROAD, BOCA RATON, FL, 33486, US

(73) Assignee: SENSORMATIC ELECTRONICS CORPORATION

(21) Appl. No.: 11/058,897

(22) Filed: Feb. 16, 2005

(51) Int. Cl. H04Q 5/22

(52) U.S. Cl. 340/10.51; 340/572.1; 340/10.1

(57) ABSTRACT

A system, apparatus and method to configure a radio-frequency identification reader may be described. For example, the apparatus may comprise a radio-frequency identification device to store configuration information for a radio-frequency identification reader. Other embodiments are described and claimed.

### BACKGROUND

A radio-frequency identification (RFID) system may be used for a number of applications, such as managing inventory, electronic access control, security systems, automatic identification of cars on toll roads, electronic article surveillance (EAS), and so forth. A RFID system may comprise a RFID reader and a RFID device. The RFID reader may transmit a radio-frequency carrier signal to the RFID device. The RFID device may respond to the carrier signal with a data signal encoded with information stored by the RFID device.

In some cases a RFID reader may need to be configured prior to or during operation. Configuring a RFID reader may include communicating certain information to the RFID reader. Improved techniques to configure a RFID reader may increase convenience to the user, as well as reduce associated costs. Accordingly, there may be need for improved techniques to configure an RFID reader in an RFID system.

### BRIEF DESCRIPTION OF THE DRAWINGS

The subject matter regarded as the embodiments is particularly pointed out and distinctly claimed in the concluding portion of the specification. The embodiments, however, both as to organization and method of operation, together with objects, features, and advantages thereof, may best be understood by reference to the following detailed description when read with the accompanying drawings in which:

FIG. 1 illustrates a system in accordance with one embodiment;

FIG. 2 illustrates a security tag in accordance with one embodiment; and

FIG. 3 illustrates a logic diagram in accordance with one embodiment.

### DETAILED DESCRIPTION

Some embodiments may be directed to an RFID system in general. More particularly, some embodiments may include a RFID reader and a RFID device. An example of an RFID device may include a security tag. The security tag may store information to configure a RFID reader. The RFID reader may read the security tag to receive the information. The RFID reader may configure itself in accordance with the received information. Other embodiments are described and claimed as well.

Numerous specific details may be set forth herein to provide a thorough understanding of the embodiments. It will be understood by those skilled in the art, however, that the embodiments may be practiced without these specific details. In other instances, well-known methods, procedures, components and circuits have not been described in detail so as not to obscure the embodiments. It can be appreciated that the specific structural and functional details disclosed herein may be representative and do not necessarily limit the scope of the embodiments.

It is worthy to note that any reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

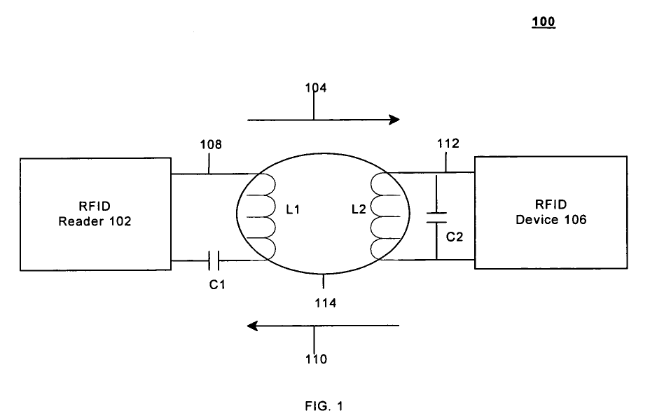

Referring now in detail to the drawings wherein like parts are designated by like reference numerals throughout, there is illustrated in FIG. 1 a first system in accordance with one embodiment. FIG. 1 is a block diagram of an RFID system 100. In one embodiment, for example, RFID system 100 may be configured to operate using an RFID device having an operating frequency in an allocated band, such as the 868 Megahertz (MHz) band, the 915 MHz band, the 950 MHz band, and so forth. RFID system 100, however, may also be configured to operate using other portions of the RF spectrum as desired for a given implementation. The embodiments are not limited in this context.

In one embodiment, RFID system 100 may comprise a RFID reader 102. RFID reader 102 may include any RFID reader arranged to read a RFID device, such as RFID device 106. In one embodiment, for example, RFID reader 102 may be implemented using a tuned circuit 108 comprising an inductor L1 and a capacitor C1 connected in series. RFID reader 102 may produce continuous wave (CW) RF power across the tuned circuit 108. This CW RF power may be electro-magnetically coupled by alternating current action to a parallel resonant circuit antenna 112 of RFID device 106. The coupled CW RF electro-magnetic power may be generally represented by the numeral 114. It may be appreciated that the above-referenced implementation of a RFID reader is given by way of example only, and the embodiments are not limited in this context.

In one embodiment, RFID system 100 may comprise a RFID device 106. RFID device 106 may include any RFID device arranged to communication information to a RFID reader, such as RFID reader 102. In one embodiment, for example, RFID device 106 may be implemented using a semiconductor integrated circuit (IC) and a tunable antenna. The tunable antenna may be tuned to a desired operating frequency by adjusting the length of the antenna. The range of operating frequencies may vary, although the embodiments may be particularly useful for ultra-high frequency (UHF) spectrum. Depending upon the application and the size of the area available for the antenna, the antenna may be tuned within several hundred MHz or higher, such as 868-950 MHz, for example. In one embodiment, for example, the tunable antenna may be tuned to operate within a certain RFID operating frequency, such as the 868 MHz band used in Europe, the 915 MHz Industrial, Scientific and Medical (ISM) band used in the United States, the 950 MHz band proposed for Japan, and so forth. It may be appreciated that the above-referenced implementation and operating frequencies of a RFID device is given by way of example only, and the embodiments are not limited in this context.

In one embodiment, RFID device 106 may comprise a RFID security tag. A RFID security tag may include memory to store RFID information, and may communicate the stored information in response to an interrogation signal, such as interrogation signals 104. RFID information may include any type of information capable of being stored in a memory used by RFID device 106. Examples of RFID information may include a unique tag identifier, a unique system identifier, an identifier for the monitored object, and so forth. The types and amount of RFID information are not limited in this context.

In one embodiment, RFID device 106 may comprise a passive RFID security tag. A passive RFID security tag does not use an external power source, but rather uses interrogation signals 104 as a power source. For example, RFID device 106 may include a power converter circuit that converts some of the coupled CW RF electro-magnetic power 114 into direct current power for use by the logic circuits of the semiconductor IC used to implement the RFID operations for RFID device 106. In this manner, RFID device 106 may be activated by a direct current voltage that is developed as a result of rectifying the incoming RF carrier signal comprising interrogation signals 104. Once RFID device 106 is activated, it may then transmit the information stored in its memory register via response signals 110. Alternatively, RFID device 106 may comprise an active RFID security tag having its own power source. The embodiments are not limited in this context.

In general operation, when antenna 112 of RFID device 106 is in proximity to tuned circuit 108 of RFID reader 102, it develops an AC voltage across antenna 112. The AC voltage across antenna 112 is rectified and when the rectified voltage becomes sufficient enough to activate RFID device 106, RFID device 106 may start to send stored data in its memory register by modulating interrogation signals 104 of RFID reader 102 to form response signals 110. RFID reader 102 may receive response signals 110 and convert them into a detected serial data word bit stream of on/off pulses representative of the information from RFID device 106.

In some instances a RFID reader such as RFID reader 102 may need to be configured. The configuration can occur prior to or during operation, for example. Configuring a RFID reader may include communicating certain information to the RFID reader. Once the RFID reader has been properly configured, the RFID reader may start or resume normal operations.

Conventional techniques to configure a RFID reader may be unsatisfactory for a number of reasons. For example, configuration operations typically require the user to connect to the RFID reader via a network connection, such as a Transport Control Protocol/Internet Protocol (TCP/IP) connection, serial connection, and so forth. Part of the configuration operation, however, is to communicate such information to the RFID reader. Consequently, a user may want to configure the initial settings so that they can communicate with the RFID reader, but the user may be unable to communicate with the RFID reader unless they already know the appropriate settings. A user may attempt to solve this problem by writing the settings down in some place that is commonly known, such as on the outside of the RFID reader or in a common list. The user may fail to update the written information, however, when the configuration is changed. Another potential solution is to perform a hard reset of the RFID reader, which usually causes the device to go back to some known default settings. The current set of configuration settings, however, may be lost. Further, the user still needs to know the default settings.

The embodiments may solve these and other problems. In one embodiment, for example, RFID device 106 may store RFID information comprising configuration information for RFID reader 102. When RFID reader 102 is in need of configuration, RFID device 106 may be placed within range of interrogation signals 104 of RFID reader 102. RFID reader 102 may receive the configuration information stored by RFID device 106 via response signals 110. RFID reader 102 may then configure itself using the configuration information received from RFID device 106. The embodiments are not limited in this context.

Configuration information may include any information used by RFID reader 102 to operate. One example of configuration information may include one or more network addresses. Examples of network addresses may include an IP address, media access control (MAC) address, TCP/IP address (e.g., possible values 0-255.0-255.0-255.0-255), dynamic host configuration protocol (DHCP) enabled (e.g., possible values yes/no or true/false), simple network management protocol (SNMP) enabled (e.g., possible values yes/no or true/false), subnet mask (e.g., possible values 0-255.0-255.0-255.0-255), default gateway (e.g., possible values 0-255.0-255.0-255.0-255), and so forth. Another example of configuration information may include RF related information, such as transmission power level (e.g., possible values determined by the reader, such as values 1-32), selection of active antennas (e.g., possible values determined by the number of antenna on the reader, such as 0, 1, 2, 3), transmission frequency (e.g., 915 Mhz, 13.56 Mhz), transmission protocol (e.g., CC915, ISO15693), and so forth. Yet another example of configuration information may include serial communications related information, such as baud rate (e.g., possible values might include 9600, 19.2 k, 28.8 k, 56 k), parity (e.g., possible values might include Odd, Even, None), stop bits (e.g., possible values might include 0, 1, 2). Still other examples of configuration information may include tag read filters (e.g., possible values might include filtering on a particular bit pattern like “00110000” being present in the tag read), activate output on read (e.g., possible values will depend on what outputs the reader has), read when input activated (e.g., possible values will depend on what inputs the reader has), and so forth. The types and values used for a particular set of configuration information may vary in accordance with a particular reader, and the embodiments are not limited in this context.

The embodiments may provide several advantages relative to conventional techniques. For example, the configuration of RFID reader 102 can be modified or restored without prior knowledge of the configuration information needed by RFID reader 102. In another example, RFID reader 102 can be configured without a separate or external user interface device, such as a mobile computer or personal digital assistant (PDA). In yet another example, RFID reader 102 may be automatically configured by positioning RFID device 106 within proximate range of interrogation signals 104, thereby reducing the need for a user to manually configure some or all of RFID reader 102.

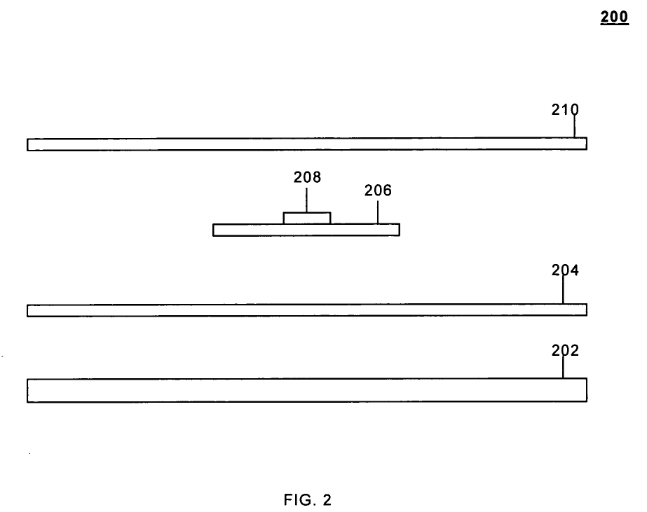

FIG. 2 illustrates a side view of a security tag in accordance with one embodiment. FIG. 2 illustrates a security tag 200. Security tag 200 may be representative of, for example, RFID device 106. As shown in FIG. 2, security tag 200 may include a substrate 202, an antenna 204, a lead frame 206, a semiconductor IC 208, and a covering material 210. Although FIG. 2 illustrates a limited number of elements, it may be appreciated that more or less elements may be used for security tag 200. For example, an adhesive and release liner may be added to security tag 200 to assist in attaching security tag 200 to an object to be monitored. The embodiments are not limited in this context.

In one embodiment, security tag 200 may include substrate 202. Substrate 202 may comprise any type of material suitable for mounting antenna 204, lead frame 206, and IC 208. For example, material for substrate 202 may include base paper, polyethylene, polyester, and so forth. The particular material implemented for substrate 202 may impact the RF performance of security tag 200. More particularly, the dielectric constant and the loss tangent may characterize the dielectric properties of an appropriate substrate material for use as substrate 202.

In general, a higher dielectric constant may cause a larger frequency shift of an antenna when compared to free space with no substrate present. Although it may be possible to re-tune the antenna to the original center frequency by physically changing the antenna pattern, it may be desirable to have the lowest dielectric constant possible for the label substrate material to improve the free-space read range. The term “read range” may refer to the communication operating distance between RFID reader 102 and RFID device 106. An example of a read range for security tag 200 may comprise 1-3 meters, although the embodiments are not limited in this context. The loss tangent may characterize the absorption of RF energy by the dielectric. The absorbed energy may be lost as heat and may be unavailable for use by IC 208. The lost energy may be same as reducing the transmitted power and may reduce the read range accordingly. Consequently, it may be desirable to have the lowest loss tangent possible in substrate 202 since it cannot be “tuned out” by adjusting antenna 204. The total frequency shift and RF loss may depend also on the thickness of substrate 202. As the thickness increases, the shift and loss may also increase.

In one embodiment, for example, substrate 202 may be implemented using base paper. The base paper may have a dielectric constant of 3.3, and a loss tangent of 0.135. The base paper may be relatively lossy at 900 MHz. The embodiments are not limited in this context.

In one embodiment, security tag 200 may include IC 208. IC 208 may comprise a semiconductor IC, such as an RFID chip or application specific integrated circuit (ASIC) (“RFID chip”). RFID chip 208 may include, for example, an RF or alternating current (AC) rectifier that converts RF or AC voltage to DC voltage, a modulation circuit that is used to transmit stored data to the RFID reader, a memory circuit that stores information, and a logic circuit that controls overall function of the device. In one embodiment, for example, RFID chip 208 may be implemented using the I-CODE or U-CODE High Frequency Smart Label (HSL) RFID ASIC made by Philips Semiconductor. The embodiments, however, are not limited in this context.

In one embodiment, security tag 200 may include lead frame 206. A lead frame may be an element of leaded packages, such as Quad Flat Pack (QFP), Small Outline Integrated Circuit (SOIC), Plastic Leaded Chip Carrier (PLCC), and so forth. Lead frame 206 may include a die mounting paddle or flag, and multiple lead fingers. The die paddle primarily serves to mechanically support the die during package manufacture. The lead fingers connect the die to the circuitry external to the package. One end of each lead finger is typically connected to a bond pad on the die by wire bonds or tape automated bonds. The other end of each lead finger is the lead, which is mechanically and electrically connected to a substrate or circuit board. Lead frame 206 may be constructed from sheet metal by stamping or etching, often followed by a finish such as plating, downset and taping. In one embodiment, for example, lead frame 206 may be implemented using a Sensormatic EAS Microlabel lead frame made by Sensormatic Corporation, for example. The embodiments, however, are not limited in this context.

In one embodiment, security tag 200 may include covering material 210. Covering material 210 may be cover stock material applied to the top of a finished security tag. As with substrate 202, covering material 210 may also impact the RF performance of RFID device 106. In one embodiment, for example, covering material 210 may be implemented using cover stock material having a dielectric constant of 3.8 and a loss tangent of 0.115. The embodiments are not limited in this context.

In one embodiment, security tag 200 may include antenna 204. Antenna 204 may be representative of, for example, antenna 112 of RFID device 106. Antenna 204 may be formed by a parallel resonant LC circuit, where L is inductance and C is capacitance. In one embodiment, for example, antenna 204 may be a tunable antenna. To increase read range, antenna 204 may be tuned to the carrier signal so that the voltage across the antenna circuit is maximized. The degree of preciseness of the tuning circuit is related to the spectrum width of the carrier signal transmitted by transmitter 102. For example, in the United States the Federal Communication Commission may regulate one band of the RFID security tag spectrum to 915 MHz. Therefore, transmitter 102 should transmit interrogation signals 104 at approximately 915 MHz. To receive interrogation signals 104, antenna 204 should be narrowly tuned to the 915 MHz signal. For 915 MHz applications, the inductance L is typically formed by printed, etched, or wired circuit. A fixed chip capacitor, silicon capacitor, or parasitic capacitor that is formed by RFID device 106 itself is typically used for the capacitor. These L and C values have wide variations in tolerance. Therefore, antenna 204 may need to be tuned to compensate for the tolerance variations of these L and C components. The tuning of an LC resonant circuit can be accomplished by either adjusting the L or C component values.

In one embodiment, security tag 200 may be arranged to store configuration information for RFID reader 102. A security tag storing configuration information may sometimes be referred to herein as a “configuration tag.” The configuration information may be used, for example, to configure RFID reader 102. For example, when security tag 200 is in proximity to RFID reader 102, security tag 200 may start to send the configuration information stored in its memory register by modulating interrogation signals 104 of RFID reader 102 to form response signals 110. RFID reader 102 may receive response signals 110, and convert them into a detected serial data word bit stream of on/off pulses representative of the configuration information from security tag 200.

In one embodiment, RFID reader 102 may parse the bit stream to retrieve specific portions of configuration information as represented by one or more bits of the bit stream. For example, the configuration information may comprise one or more settings, values or parameters (collectively referred to herein as “parameter”) for RFID reader 102. The format or field size for each configuration parameter may vary according to a given implementation. For example, a first set of bits may be used to represent a tag identifier, a second set of bits may be used to represent a configuration identifier, a third set of bits may be used to represent a network address, a fourth set of bits may be used to represent a port number, and so forth. The number, type and size of the specific configuration parameters may vary for a given implementation, and the embodiments are not limited in this context.

Since RFID reader 102 typically includes a greater amount of memory resources relative to security tag 200, RFID reader 102 may be used to store a greater amount of configuration information than otherwise available to security tag 200. Security tag 200 may be used to select the particular type of configuration settings desired for a given user or implementation.

In one embodiment, for example, RFID reader 102 may be arranged to store multiple configuration profiles. A configuration profile may represent a preset number of configuration parameters. The configuration profiles may then be tied within the reader to a particular RFID tag. For example, when RFID reader 102 is reset, it would attempt to read any security tags in the field, such as security tag 200. RFID reader 102 may receive response signals 110 from security tag 200. RFID reader 102 may parse the received bit stream to determine whether security tag 200 is a configuration tag. This may be accomplished using, for example, a tag identifier associated with security tag 200. If RFID reader 102 determines that security tag 200 is a configuration tag, RFID reader 102 may parse the bit stream to retrieve a configuration identifier. RFID reader 102 may use the configuration identifier to select a configuration profile stored by RFID reader 102 and corresponding to the configuration identifier stored by security tag 200. The embodiments are not limited in this context.

In one embodiment, for example, RFID reader 102 may be configured using multiple security tags. For example, security tag 200 may comprise one of multiple configuration tags. Each configuration tag may have a subset of the configuration information desired for RFID reader 102 encoded directly on the tag. For example, a first configuration tag may store an IP address, a second configuration tag may store a particular read frequency, a third configuration tag may have a particular baud rate, and so forth. When RFID reader 102 is reset, one or more of the configuration tags may be selected to form a set of tags representing the desired configuration, and the entire set could be placed in sequence or parallel into the read field of RFID reader 102 to configure RFID reader 102. This embodiment may provide additional flexibility for a user, since certain configuration settings corresponding to the particular set of configuration tags may be reset, while other configuration settings may remain as they are currently configured. For example, a user might select a set of configuration tags having an IP address 192.68.40.10, subnet mask 255.255.255.0, gateway 192.10.40.100, DHCP false, SNMP false, transmission power 16, active antennas 0, 4, transmission protocol CC915, and tag filter “0011000” in bits 1 through 8. The embodiments are not limited in this context.

In one embodiment, security tag 200 may be arranged to have a sufficient amount of memory to store an entire configuration profile for RFID reader 102. For example, security tag 200 may be implemented using a “Class 4” tag. In this case, when RFID reader 102 is reset, RFID reader 102 may read the Class 4 security tag 200 to retrieve the entire configuration profile, and configure RFID reader 102 in accordance with the particular configuration profile. The embodiments are not limited in this context.

RFID reader 102 may be arranged to read one or more configuration tags in a number of different ways. For example, RFID reader 102 may scan for configuration tags for a preset period of time and at a preset frequency after a reset operation has occurred. RFID reader 102 may be reset in a number of ways, such as by powering down and then powering up RFID reader 102, depressing a reset button, receiving a software command or interrupt, and so forth. This technique may reduce the overall amount of time RFID reader 102 would look for configuration tags thereby allowing more time to read data tags. In another example, RFID reader 102 may periodically scan for the presence of configuration tags. The selected time period may vary according to various implementations. For example, the selected time period may be set to scan once every 30 seconds. In yet another example, RFID reader 102 may continuously scan for configuration tags while in operation. The embodiments are not limited in this context.

Operations for the above elements may be further described with reference to the following figures and accompanying examples. Some of the figures may include a logic diagram. Although such figures presented herein may include a particular logic diagram, it can be appreciated that the logic diagram merely provides an example of how the general functionality as described herein can be implemented. Further, the given logic does not necessarily have to be executed in the order presented unless otherwise indicated. In addition, the logic diagram may be implemented by one or more hardware elements, a software element executed by a processor, or any combination thereof. The embodiments are not limited in this context.

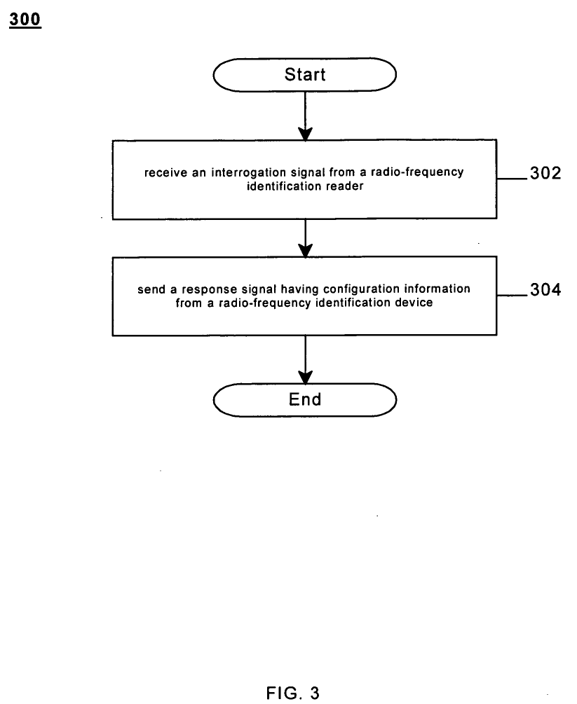

FIG. 3 illustrates a logic diagram in accordance with one embodiment. FIG. 3 illustrates a logic diagram 400. Logic diagram 400 may be representative of the operations executed by one or more structures described herein, such as system 100, RFID reader 102, RFID device 106, and/or security tag 200. As shown in logic diagram 400, an interrogation signal may be received from a RFID reader. A response signal having configuration information may be sent from a RFID device. The RFID device may comprise, for example, a configuration tag. The RFID reader may receive the configuration information from the RFID device, and configure itself using the configuration information. For example, the RFID reader may select one of a multiple set of configuration profiles to configure itself in accordance with the configuration information.

Some embodiments may be implemented using an architecture that may vary in accordance with any number of factors, such as desired computational rate, power levels, heat tolerances, processing cycle budget, input data rates, output data rates, memory resources, data bus speeds and other performance constraints. For example, an embodiment for RFID reader 102 may be implemented using software executed by a general-purpose or special-purpose processor. In another example, an embodiment for RFID reader 102 may be implemented as dedicated hardware, such as a circuit, an ASIC, Programmable Logic Device (PLD) or digital signal processor (DSP), and so forth. In yet another example, an embodiment for RFID reader 102 may be implemented by any combination of programmed general-purpose computer components and custom hardware components. The embodiments are not limited in this context.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

1. An apparatus comprising a radio-frequency identification device to store configuration information for a radio-frequency identification reader.

2. The apparatus of claim 1, said radio-frequency identification device to receive an interrogation signal, and transmit a response signal having said configuration information.

3. The apparatus of claim 1, said radio-frequency identification device to store a portion of said configuration information.

4. The apparatus of claim 1, said radio-frequency identification device to store a complete set of configuration information for said radio-frequency identification reader.

5. The apparatus of claim 1, wherein said configuration information comprises at least one of a network address, operating frequency and baud rate.

6. An apparatus comprising a radio-frequency identification reader to receive a first set of configuration information from a first radio-frequency identification device.

7. The apparatus of claim 1, wherein said radio-frequency identification reader is to use said first set of configuration information to configure said radio-frequency identification reader.

8. The apparatus of claim 1, wherein said radio-frequency identification reader is to store multiple configuration profiles, and select one of said multiple configuration profiles to configure said radio-frequency identification reader in accordance with said first set of configuration information.

9. The apparatus of claim 1, wherein said radio-frequency identification reader is to receive a second set of configuration information from a second radio-frequency identification device.

10. The apparatus of claim 9, wherein said radio-frequency identification reader is to use said first set of configuration information and said second set of configuration information to configure said radio-frequency identification reader.

11. A system, comprising:
a radio-frequency identification reader to generate interrogation signals; and
a first radio-frequency identification device to receive said interrogation signal, said radio-frequency identification device to transmit a response signal having a first set of configuration information for said radio-frequency identification reader.

12. The system of claim 11, wherein said first set of configuration information comprises at least one of a network address, operating frequency and baud rate.

13. The system of claim 11, wherein said radio-frequency identification reader is to use said first set of configuration information to configure said radio-frequency identification reader.

14. The system of claim 11, wherein said radio-frequency identification reader is to store multiple configuration profiles, and select one of said multiple configuration profiles to configure said radio-frequency identification reader in accordance with said first set of configuration information.

15. The system of claim 11, further comprising a second radio-frequency identification device, wherein said radio-frequency identification reader is to receive a second set of configuration information from said second radio-frequency identification device.

16. The system of claim 11, wherein said radio-frequency identification reader is to use said first set of configuration information and said second set of configuration information to configure said radio-frequency identification reader.

17. A method, comprising:
receiving an interrogation signal from a radio-frequency identification reader; and
sending a response signal having configuration information from a radio-frequency identification device.

18. The method of claim 17, further comprising receiving said configuration information from said radio-frequency identification device.

19. The method of claim 18, further comprising configuring said radio-frequency identification reader using said configuration information.

20. The method of claim 18, further comprising selecting one of a multiple set of configuration profiles to configure said radio-frequency identification reader in accordance with said configuration information.

21. The method of claim 20, further comprising configuring said radio-frequency identification reader using said configuration profile.
